(19) United States
(12) Patent Application Publication
(10) Pub. No.: US 2015/0147079 A1
(43) Pub. Date: May 28, 2015

(54) IMAGE FORMING APPARATUS AND CHARGE CONTROL METHOD

(71) Applicants: Atsuki IWATA, Tokyo (JP); Takanobu SAITOH, Kanagawa (JP); Tetsuya YANO, Kanagawa (JP); Tsuyoshi ENDOH, Kanagawa (JP); Shuntaroh NAKAYAMA, Kanagawa (JP); Toshimasa AOKI, Kanagawa (JP); Seiya OGAWA, Kanagawa (JP)

(72) Inventors: Atsuki IWATA, Tokyo (JP); Takanobu SAITOH, Kanagawa (JP); Tetsuya YANO, Kanagawa (JP); Tsuyoshi ENDOH, Kanagawa (JP); Shuntaroh NAKAYAMA, Kanagawa (JP); Toshimasa AOKI, Kanagawa (JP); Seiya OGAWA, Kanagawa (JP)

(73) Assignee: RICOH COMPANY, LTD., Tokyo (JP)

(21) Appl. No.: 14/522,714

(22) Filed: Oct. 24, 2014

(30) Foreign Application Priority Data
Nov. 28, 2013 (JP) 2013-246638

(51) Int. Cl. G03G 15/00

(52) U.S. Cl. CPC G03G 15/5004
USPC 399/88

(57) ABSTRACT

An image forming apparatus includes a plurality of power generation units, a charge control unit, a charge switch unit, and a controller, Each of the plurality of power generation units is respectively provided to a corresponding one of a plurality of high-temperature portions in the image forming apparatus to generate power based on temperatures of the high-temperature portions. The charge control unit charges a power storage unit with electrical energy generated by the power generation units. The charge switch unit switches between the power generation units to connect one of the power generation units to the charge control unit. The controller controls the charge switch unit to selectively connect one of the power generation units capable of achieving a maximum power generation efficiency to the charge control unit.

### CROSS-REFERENCE TO RELATED APPLICATION

This patent application is based on and claims priority pursuant to 35 U.S.C. §119(a) to Japanese Patent Application No. 2013-246638. filed on Nov. 28, 2013, in the Japan Patent Office, the entire disclosure of which is hereby incorporated by reference herein.

### BACKGROUND

1. Technical Field

This disclosure relates to an image forming apparatus and a charge control method.

2. Related Art

An electrophotographic image forming apparatus is equipped with a plurality of heat sources including a fixing heater. In a start-up or image forming operation, therefore, different parts of the image forming apparatus have different temperatures owing to the heat generated in the operation, making the temperature distribution in the image forming apparatus uneven. The uneven temperature distribution, i.e., the difference in temperature between high-temperature portions and low-temperature portions in the image forming apparatus, is used to convert temperature energy into electrical energy with a Peltier element or the like.

The above-described technique mainly takes advantage of a high-temperature portion near a fixing device in the image forming apparatus. As well as the high-temperature portion near the fixing device, the image forming apparatus has other high-temperature portions, such as radiator plates for a direct-current power supply, an alternating-current control plate, and a motor driver. Therefore, such high-temperature portions may be converted into the electrical energy to generate power. The generated electricity may be efficiently stored in a power storage device with a maximum power point tracker (MPPT) circuit or the like.

### SUMMARY

In one embodiment of this disclosure, there is provided an improved image forming apparatus that, in one example, includes a plurality of power generation units, a charge control unit, a charge switch unit, and a controller. Each of the plurality of power generation units is respectively provided to a corresponding one of a plurality of high-temperature portions in the image forming apparatus to generate power based on temperatures of the high-temperature portions. The charge control unit charges a power storage unit with electrical energy generated by the power generation units. The charge switch unit switches between the power generation units to connect one of the power generation units to the charge control unit. The controller controls the charge switch unit to selectively connect one of the power generation units capable of achieving a maximum power generation efficiency to the charge control unit.

In one embodiment of this disclosure, there is provided an improved charge control method for an image forming apparatus including a plurality of power generation units each respectively provided to a corresponding one of a plurality of high-temperature portions in the image forming apparatus to generate power based on temperatures of the high-temperature portions and a power storage unit to be charged with electrical energy generated by the power generation units. The charge control method includes, in one example, charging the power storage unit with the electrical energy generated by the power generation units, and switching between the power generation units to selectively connect one of the power generation units capable of achieving a maximum power generation efficiency to the power storage unit.

### BRIEF DESCRIPTION OF THE DRAWINGS

A more complete appreciation of this disclosure and many of the advantages thereof are obtained as the same becomes better understood by reference to the following detailed description when considered in connection with the accompanying drawings, wherein:

FIG. 1 is a schematic diagram illustrating a configuration of an image forming apparatus according to an embodiment of this disclosure;

FIG. 2 is a block diagram illustrating a control configuration or the image forming apparatus;

FIG. 3 is a block diagram illustrating a configuration for controlling charging with electrical energy generated by temperature differences;

FIG. 4 is a block diagram illustrating a specific example of the control configuration according to the embodiment illustrated in FIG. 3; and

FIG. 5 is a time chart illustrating a charging process according to the specific example illustrated in FIG. 4.

### DETAILED DESCRIPTION

In describing the embodiments illustrated in the drawings, specific terminology is adopted for clarity. However, this disclosure is not intended to be limited to the specific terminology so used, and it is to be understood that substitutions for each specific element can include any technical equivalents that have the same function, operate in a similar manner, and achieve a similar result.

Referring now to the drawings, wherein like reference numerals designate identical or corresponding parts throughout the several views, an embodiment of this disclosure will be described.

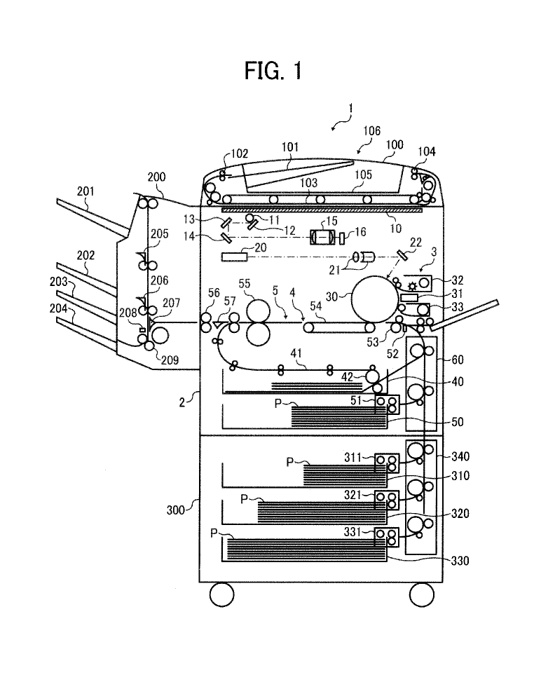

FIG. 1 is a schematic diagram illustrating a configuration of an image forming apparatus 1 according to the present embodiment. The image forming apparatus 1 includes a main unit 2, an image reading unit 100 disposed on the main unit 2, a sheet feeding unit 300 disposed under the main unit 2, and a sheet discharging unit 200 disposed on a side surface of the main unit 2.

In the image reading unit 100, an automatic document feeder (ADF) 106 including sheet feed rollers 102, a transport belt 103, and sheet discharge rollers 104 transports a document placed on a sheet feed table 101 onto an exposure glass 10 and then to a sheet discharge tray 105. Further, in the image reading unit 100, the document moving over the exposure glass 10 is exposed by an exposure lamp unit 11 to be optically scanned, and the image of the document is read by a reading sensor 16, such as a charge-coupled device (CCD), via first to third mirrors 12 to 14 and a lens 15.

The sheet feeding unit 300 includes a plurality of sheet feed trays 310, 320, and 330 serving as sheet feed units for sheets P serving as recording media. In the sheet feeding unit 300, feeders 311, 321, and 331 feed the sheets P one by one from the sheet feed trays 310, 320, and 330, respectively, and a transport unit 340 including a plurality of transport rollers transports the sheets P to the main unit 2.

In the main unit 2, a transport unit 60 transports a sheet P fed from the sheet feeding unit 300 or a sheet P fed by a feeder 51 from a main unit sheet feed tray 50 serving as a sheet feed unit in the main unit 2 to a photoconductor drum 30.

In the main unit 2, a charger 31 uniformly charges the outer circumferential surface of the photoconductor drum 30 being rotated, and a writing unit 20 writes an image on the outer circumferential surface of the photoconductor drum 30. Specifically, the writing unit 20 generates a laser beam serving as exposure light, and applies the laser beam to the photoconductor drum 30, i.e., exposes the photoconductor drum 30 to the laser beam, via an fθ lens 21 and a mirror 22. Thereby, an electrostatic latent image corresponding to an image to be printed is formed on the photoconductor drum 30. Then, a development unit 32 develops the electrostatic latent image on the photoconductor drum 30 with toner of a predetermined color (e.g., black) to form a toner image on the outer circumferential surface of the photoconductor drum 30. The sheet P is detected by a sheet sensor 52 and fed by registration rollers 53 such that the sheet P faces the toner image formed on the photoconductor drum 30. Thereby, the toner image is transferred onto the sheet P passing between a transport belt 54, which also serves as a transfer belt, and the photoconductor drum 30. Thereafter, a cleaning device 33 removes unnecessary toner remaining on the outer circumferential surface of the photoconductor drum 30, and the outer circumferential surface of the photoconductor drum 30 is discharged by a discharging device, The sheet P is then fed between paired fixing rollers in a fixing unit 55 to be heated and pressed. Thereby, the toner image is fixed on the sheet P.

In the image forming apparatus 1 according to the present embodiment, the photoconductor drum 30, the development unit 32, the writing unit 20, and the fixing unit 55 form a printing device 3 for printing an image on a sheet P. The printing device 3 prints an image on a single sheet P or sequentially forms images on a plurality of sheets P, to thereby form an image on each sheet P. To print images on both surfaces of a sheet P, an image is first printed on one surface of the sheet P, and then the sheet P is transported to a duplex print tray 40 via a duplex print path 41 by a switch pawl 57 and re-fed to the transport unit 60 by sheet re-feed rollers 42 to print an image on the other surface of the sheet P.

The sheet P subjected to the printing process is transported to the sheet discharging unit 200 by transport rollers 56. In the sheet discharging unit 200 including a plurality of sheet discharge trays 201, 202, 203, and 204 serving as sheet discharge units for the sheet P, a transport path for the sheet P is changed by switch pawls 205, 206, and 207 to discharge the sheet P to a selected destination. For example, the sheet P is detected by a sheet sensor 208 and discharged onto the lowest sheet discharge tray 204 by sheet discharge rollers 209.

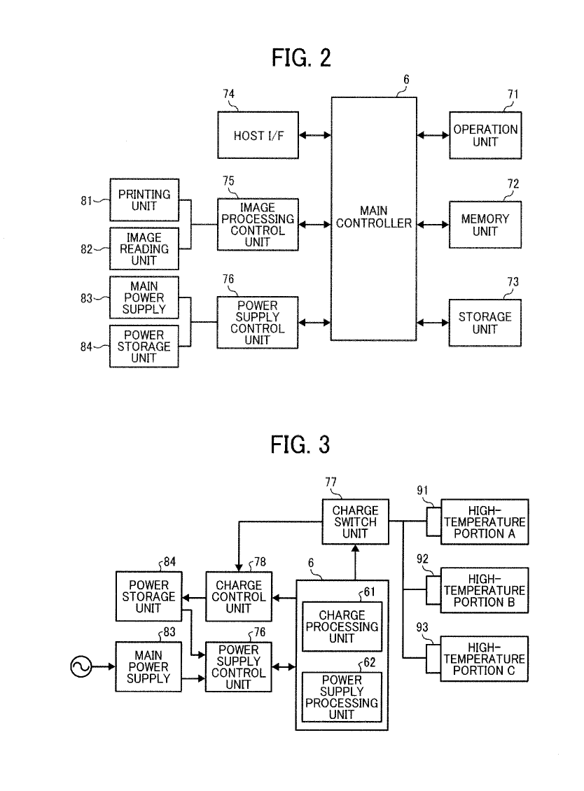

In the image forming apparatus 1 according to the present embodiment, the transport units 340 and 60, the transport belt 54, and other components such as transport rollers, switch pawls, sheet sensors, and motors provided along the transport path for the sheet P form a transport mechanism 4 that transports the sheet P. Further, the transport mechanism 4 and a control unit for controlling the transport mechanism 4, the sheet feeding unit 300, and the sheet discharging unit 200 and a sheet transport control unit included in a later-described main controller 6 in FIG. 2 form a transport device 5 that controls the transport of the sheet P. The transport device 5 controls the transport mechanism 4 to transport the sheet P fed from a predetermined sheet feed unit (i.e., the sheet feed tray 310, 320, 330, or 50) to a predetermined sheet discharge unit (i.e., the sheet discharge tray 201, 202, 203, or 204) along the transport path in the image forming apparatus 1. The transport device 5 also transports the sheet P to the printing device 3 to print an image on the sheet P. The transport device 5 thus transports the sheet P from a sheet feed unit to a sheet discharge unit through the printing device 3.

FIG. 2 is a block diagram illustrating a control configuration for the image forming apparatus 1. The image forming apparatus 1 includes the main controller 6 including a central processing unit (CPU), an operation unit 71 including a touch panel and key buttons, a memory unit 72 including a read-only memory (ROM) and a random access memory (RAM), a storage unit 73 including a storage device such as a hard disk (HD), a host interface (I/F) 74 for transmitting and receiving data to and from an external network, an image processing control unit 75, and a power supply control unit 76.

The main controller 6 exerts overall control of the image forming apparatus 1 by reading programs and data stored in the memory unit 72 and the storage unit 73. When the touch panel and key buttons of the operation unit 71 are operated, data necessary for an image forming process is input. The image processing control unit 75 performs image processing by processing image data read by an image reading unit 82 or image data transmitted from the external network to allow a printing unit 81 to print an image based on the processed image data. The power supply control unit 76 controls power supply to various units in the image forming apparatus 1 by switching between a main power supply 83 connected to a commercial power source and a power storage unit 84. The main power supply 83 may be, for example, an alternating-current/direct-current (AC/DC) power supply that converts the power supplied from the commercial power source into DC power and supplies the DC power to the units in the image forming apparatus 1. The power storage unit 84, which is a chargeable device such as a secondary battery or a capacitor, for example, is charged with electrical energy obtained by power generation based on the difference in temperature between different portions in the image forming apparatus 1, as described below.

FIG. 3 is a block diagram illustrating a configuration for controlling charging with the electrical energy obtained by the power generation based on the temperature difference. In this embodiment, three power generation units 91, 92, and 93 are provided to three high-temperature portions A, B, and C in the image forming apparatus 1. Preferably, each of the high-temperature portions A, B, and C is a location provided with a radiator plate, such as the fixing unit 55, the CPU, or the discharging device, for example. Each of the power generation units 91, 92, and 93 may include an element that converts the temperature difference into electrical energy, such as a Peltier element, for example. The number of power generation units provided to high-temperature portions is not limited to three, and may be any plural number.

The power generation units 91, 92, and 93 are connected to a charge switch unit 77 to supply the power generated by the power generation units 91, 92, and 93 to the charge switch unit 77. The charge switch unit 77 is connected to a charge control unit 78 and switches between the power generation units 91, 92, and 93 to be connected thereto, to thereby selectively connect one of the power generation units 91, 92, and 93 to the charge control unit 78. The charge control unit 78, which includes an MPPT circuit, for example, efficiently controls charging of the power storage unit 84 by supplying the power from the connected one of the power generation units 91, 92, and 93 to the power storage unit 84.

The main controller 6 includes a charge processing unit 61 and a power supply processing unit 62. The charge processing unit 61 controls the switching process of the charge switch unit 77 and the charging process of the charge control unit 78. For example, in the switching process of the charge switch unit 77, the charge processing unit 61 predicts the respective temperatures of the high-temperature portions A, B, and C and switches to one of the power generation units 91, 92, and 93 corresponding to the high-temperature portions A, B, and C capable of achieving the maximum power generation efficiency to use the selected one of the power generation units 91, 92, and 93 for charging.

The temperatures of the high-temperature portions A, B, and C may be predicted from an increase in temperature detected with temperature sensors provided to the high-temperature portions A, B, and C. Alternatively, the temperatures of the high-temperature portions A, B, and C in respective operational states (e.g., a copy mode, a standby mode, and a sleep mode) of the image forming apparatus 1 may previously be measured, and one of the power generation units 91, 92, and 93 corresponding to the high-temperature portions A, B, and C expected to have the highest temperature in a selected operational state may be selected.

Still alternatively, actual temperature histories of the high-temperature portions A, B, and C based on the operation history and the operation time of the image forming apparatus 1 may be stored, and one of the power generation units 91, 92, and 93 corresponding the high-temperature portions A, B, and C expected to have the highest temperature based on the stored temperature histories may be selected. With this switching process, one of the power generation units 91, 92, and 93 capable of most efficiently generating power is selected in the charging process.

In the charging process of the charge control unit 78, the charge processing unit 61 controls the charging by causing the charge control unit 78 to output the power supplied from one of the power generation units 91, 92, and 93 to the power storage unit 84. For example, the charge processing unit 61 controls the charging by causing the charge control unit 78 to check the chargeable amount in the power storage unit 84 and charge the power storage unit 84 in accordance with the chargeable amount.

The above-described configuration obviates the need to provide a charge control unit for each of the power generation units 91, 92, and 93, making it possible to charge the power storage unit 84 by selecting, with a simple circuit configuration, one of the power generation units 91, 92, and 93 capable of achieving the maximum power generation efficiency. Accordingly, the space and cost for installing components for charging are reduced, and the charging is efficiently performed with a large amount of electrical energy in a short time.

The power supply processing unit 62 controls the power supply control unit 76 to switch between the main power supply 83 (e.g., AC/DC power supply) and the power storage unit 84 to supply power to the various units in the image forming apparatus 1. For example, during the operation of the image forming apparatus 1, in which a large amount of power is necessary, the power supply control unit 76 switches to the main power supply 83 to supply power therefrom. Meanwhile, in the standby or sleep mode of the image forming apparatus 1, in which the power consumption is small, the power supply control unit 76 switches to the power storage unit 84 to supply power therefrom. With this power supply switching process, the image forming apparatus 1 has improved energy-saving performance.

The main power supply 83 supplies a constant voltage of 5 V, 12 V or 24 V, for example, to the power supply control unit 76. The power supply control unit 76 switches the constant voltage source between the main power supply 83 and the power storage unit 84.

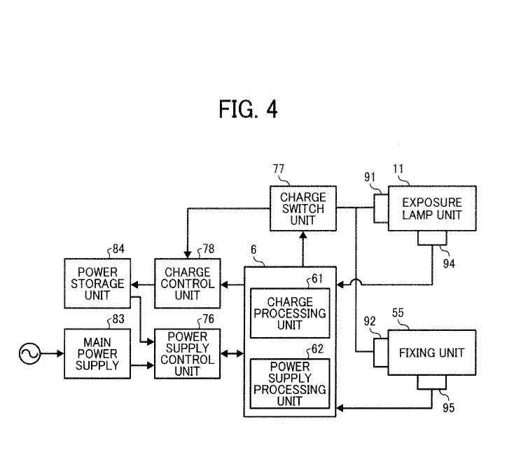

FIG. 4 is a block diagram illustrating a specific example of the control configuration according to the embodiment illustrated in FIG. 3. Components in FIG. 4 similar to to those in FIG. 3 are designated by the same reference numerals, and description thereof will be omitted to avoid redundancy.

In FIG. 4, the exposure lamp unit 11 in the image reading unit 100 and the fixing unit 55 including the fixing rollers serve as two high-temperature portions. These two high-temperature portions are respectively provided with temperature sensors 94 and 95, which output detection signals to the main controller 6. Accordingly, the main controller 6 is capable of selecting one of the power generation units 91 and 92 corresponding to the high-temperature portions (i.e., the exposure lamp unit 11 and the fixing unit 55) based on the temperatures detected at the two locations.

For example, in an image reading operation or a facsimile transmission operation, the exposure lamp unit 11 is heated to a high temperature. In this case, therefore, the power generation unit 91 provided to the exposure lamp unit 11 is selected to charge the power storage unit 84 with the power generated by the power generation unit 91. By contrast, in a printing operation, the fixing unit 55 is heated to a high temperature. In this case, therefore, the power generation unit 92 provided to the fixing unit 55 is selected to charge the power storage unit 84 with the power generated by the power generation unit 92. In a copy operation, which one of the exposure lamp unit II and the fixing unit 55 is capable of achieving the higher power generation efficiency is determined based on the respective temperatures thereof, and one of the power generation units 91 and 92 is selected based on the determination to charge the power storage unit 84 with the power generated by the selected one of the power generation units 91 and 92. Since one of the power generation units 91 and 92 capable of achieving the higher power generation efficiency is thus selected for charging the power storage unit 84, the power storage unit 84 is charged with the electrical energy efficiently generated in a short time.

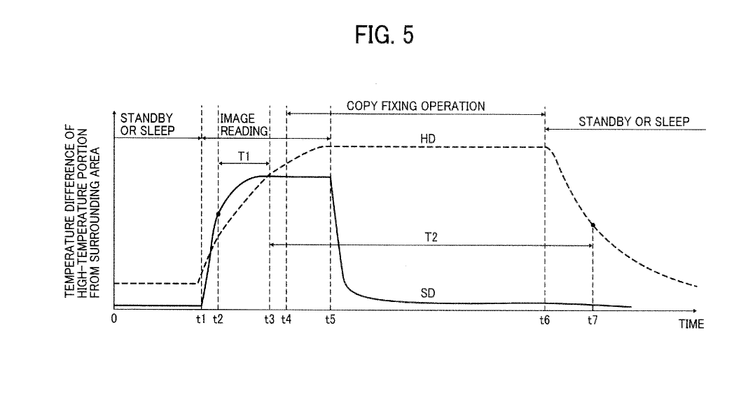

FIG. 5 is a time chart illustrating the charging process according to the specific example illustrated in FIG. 4. The horizontal axis represents the time, and the vertical axis represents the temperature difference of the temperature of a high-temperature portion provided with a power generation unit from the temperature of a low-temperature portion around the high-temperature portion. A broken curve HD indicates a change in the temperature difference of the fixing unit 55, and a solid curve SD indicates a change in the temperature difference of the exposure lamp unit 11.

The operation mode of the image forming apparatus 1 is initially set to the standby or sleep mode, in which the fixing unit 55 has a slight temperature difference with respect to the surrounding area and the exposure lamp unit 11 has little temperature difference close to zero. In this state, power is supplied from the previously charged power storage unit 84, and the image forming apparatus 1 is placed in the standby or sleep mode. That is, the power supply control unit 76 switches to the power storage unit 84 to cut off power supply from the main power supply 83. With no power supplied to the image forming apparatus 1 from outside, energy saving is achieved.

At a time t1, a copy job starts. That is, a copy operation is instructed through the operation unit 71, and an input of the instruction for the operation is confirmed. Then, the main controller 6 controls the power supply control unit 76 to switch to the main power supply 83 from the power storage unit 84, to thereby change the source of power supply to the main power supply 83. With the start of the copy job, a continuous document (i.e., image) reading operation is performed, and the temperature difference of the exposure lamp unit 11 with the surrounding area rapidly increases. Further, the fixing unit 55 is supplied with power and heats up, gradually increasing the temperature difference of the fixing unit 55 with the surrounding area. The change in the temperature difference of each of the exposure lamp unit 11 and the fixing unit 55 according to the increase in temperature is calculated based on the detection signals transmitted from the temperature sensors 94 and 95 attached to the exposure lamp unit 11 and the fixing unit 55.

At a time t2, it is determined from the detection signal from the temperature sensor 94 that, with the increase in temperature of the exposure lamp unit 11, the temperature difference of the exposure lamp unit 11 has reached a level at which the power generation is possible. Therefore, the main controller 6 controls the charge switch unit 77 to switch the connection to the power generation unit 91 provided to the exposure lamp unit 11. The power generation unit 91 then starts generating power, and the power storage unit 84 starts to be charged with electrical energy supplied from the power generation unit 91.

After a time t3, the temperature difference of the fixing unit 55 exceeds the temperature difference of the exposure lamp unit 11 owing to the increase in temperature of the fixing unit 55. It is therefore determined that the power generation unit 92 provided to the fixing unit 55 is capable of achieving the higher power generation efficiency. Thus, the main controller 6 controls the charge switch unit 77 to switch the connection from the power generation unit 91 to the power generation unit 92. Thereby, electrical energy obtained from the power generation by the power generation unit 92 is supplied to and charged in the power storage unit 84.

During a period T1 between the times t2 and t3, therefore, the power storage unit 84 is continuously charged with the electrical energy from the power generation unit 91 provided to the exposure lamp unit 11.

At a time t4, the temperature of the fixing unit 55 reaches a level at which the fixing operation is possible, and a sheet feeding operation in the copy operation starts. At a time t5, the document (i.e., image) reading operation is completed, and the exposure lamp unit 11 is turned off. Therefore, the temperature of the exposure lamp unit 11 falls thereafter, thereby reducing the temperature difference of the exposure lamp unit 11. At a time t6, the copy operation is completed, and heat control of the fixing unit 55 is stopped. Therefore, the temperature of the fixing unit 55 falls thereafter, thereby reducing the temperature difference of the fixing unit 55. After the completion of the copy operation, the image forming apparatus 1 shifts to the standby or sleep mode. At a time t7, with the fall of the temperature of the fixing unit 55, the temperature difference of the fixing unit 55 is reduced to the lowest level at which power generation is possible, and then power generation stops.

During a period T2 between the times t3 and t7, therefore, the power storage unit 84 is continuously charged with the electrical energy from the power generation unit 92 provided to the fixing unit 55. Thereafter, the main controller 6 controls the charge switch unit 77 to disconnect from the power generation unit 92 to stop the power generation in and charging from the power generation unit 92. The main controller 6 further controls the power supply control unit 76 to switch from the main power supply 83 to the power storage unit 84, to thereby change the source of power supply to the power storage unit 84.

In the charging process in the above-described specific example, one of the power generation units 91 and 92 is selected based on the detection signals from the temperature sensors 94 and 95. Alternatively, the change in the temperature difference of each of the high-temperature portions with their respective surrounding areas according to the change in the operational state of the image forming apparatus 1 may be preprogrammed, and one of the power generation units 91 and 92 may be selected based on the stored change in the temperature difference.

As described above, according to the present embodiment, a high-temperature portion heated to a temperature for achieving the maximum power generation efficiency is selected from the plurality of high-temperature portions in the image forming apparatus 1, and the power generation unit provided to the selected high-temperature portion is connected to the power storage unit 84 to charge the power storage unit 84. In this configuration, therefore, circuit components for use in the charge control, such as an MPPT circuit, are shared by the plural power generation units, making it possible to efficiently perform the charging process with a simple circuit configuration. The present configuration also minimizes the space and cost for installing circuit components for use in charging, contributing to a reduction in size and price of the image forming apparatus 1.

Further, according to the present embodiment, the power generation unit provided to the high-temperature portion capable of achieving the maximum power generation efficiency is selected in accordance with the respective temperatures of the high-temperature portions during the start-up or operation of the image forming apparatus 1, and the power storage unit 84 is charged with power generated by the selected power generation unit. Accordingly, the power storage unit 84 is efficiently charged in a short time. Further, since the power charged in the power storage unit 84 is effectively used in the standby or sleep mode, the image forming apparatus 1 has improved energy-saving performance. Furthermore, since the power generation unit to be connected is changed based on the respective temperatures of the plurality of high-temperature portions, each of the high-temperature portions restores the temperature during the time in which the corresponding power generation unit is unconnected and not generating power. Consequently, a larger amount of power is obtainable than in a configuration in which a single power generation unit continuously generates power.

According to an embodiment of this disclosure, an image forming apparatus is charged by switching between power generation units provided to a plurality of high-temperature portions. Accordingly, the image forming apparatus is efficiently charged with a simple circuit configuration.

The above-described embodiments are illustrative and do not limit this disclosure. Thus, numerous additional modifications and variations are possible in light of the above teachings. For example, elements or features of different illustrative and embodiments herein may be combined with or substituted for each other within the scope of this disclosure and the appended claims. Further, features of components of the embodiments, such as number, position, and shape, are not limited to those of the disclosed embodiments and thus may be set as preferred. Further, the above-described steps are not limited to the order disclosed herein, It is therefore to be understood that, within the scope of the appended claims, the disclosure of this disclosure may be practiced otherwise than as specifically described herein.

What is claimed is:

1. An image forming apparatus comprising:
a plurality of power generation units, each respectively provided to a corresponding one of a plurality of high-temperature portions in the image forming apparatus to generate power based on temperatures of the high-temperature portions;
a charge control unit to charge a power storage unit with electrical energy generated by the power generation units;
a charge switch unit to switch between the power generation units to connect one of the power generation units to the charge control unit; and
a controller to control the charge switch unit to selectively connect one of the power generation units capable of achieving a maximum power generation efficiency to the charge control unit.

2. The image forming apparatus according to claim 1, further comprising temperature sensors respectively provided to the high-temperature portions, wherein the controller selects the one of the power generation units based on detection signals transmitted from the temperature sensors.

3. The image forming apparatus according to claim I, wherein the controller selects the one of the power generation units based on an operational state of the image forming apparatus.

4. The image forming apparatus according to claim 1, wherein each of the power generation units includes a Peltier element.

5. The image forming apparatus according to claim 1, wherein the charge control unit includes a maximum power point tracker circuit.

6. A charge control method for an image forming apparatus including a plurality of power generation units each respectively provided to a corresponding one of a plurality of high-temperature portions in the image forming apparatus to generate power based on temperatures of the high-temperature portions and a power storage unit to be charged with electrical energy generated by the power generation units,
the charge control method comprising:
charging the power storage unit with the electrical energy generated by the power generation units; and
switching between the power generation units to selectively connect one of the power generation units capable of achieving a maximum power generation efficiency to the power storage unit.
